(19) United States
(12) Patent Application Publication
(10) Pub. No.: US 2005/0263109 A1
(43) Pub. Date: Dec. 1, 2005

(54) SYSTEMS AND METHODS FOR MONITORING THE STATUS OF PRESSURIZED SYSTEMS

(76) Inventors: Timothy A. Daniels, Haltom City, TX (US); Daniel Grant Harris, Maypearl, TX (US)

Correspondence Address: GLENN L. WEBB, P.O BOX 951, CONIFER, CO, 80433, US

(21) Appl. No.: 10/707,028

(22) Filed: Nov. 16, 2003

(51) Int. Cl. F01P 5/14; B60Q 1/00

(52) U.S. Cl. 123/41.15; 340/452

(57) ABSTRACT

The monitoring system has particularly utility in monitoring the coolant system of an internal combustion engine of an automotive vehicle. The system will alert the driver of changes in the coolant system due to leaks or overheating much faster than a conventional temperature gauge. The system includes a low pressure switch connected to the coolant system by a manifold and a high pressure switch connected to the manifold. Each of these pressure switches are connected to alert displays, such as LEDs. If the pressure of the coolant system is below a preset limit, the low pressure display will alert the operator. Similarly, if the pressure of the coolant system exceeds a preset limit, the high pressure system will alert the operator. A pressure gauge can also be incorporated into this system to provide a constant status report of the pressure of the coolant system. This is particularly useful when the LEDs are powered down.

### BACKGROUND OF INVENTION

Most internal combustion engines as used in current automotive technology use a partially closed loop coolant system to dissipate heat generated by operation of the engine. The operation of the coolant system involves the interaction of heat and pressure. As the coolant heats up during operation of the engine, the pressure within the coolant system begins to build. The rate of increase of the pressure within the coolant system is consistent with the rate of increase in the temperature as it nears the boiling point of the coolant which is consistent with the principles of the Real Gas Law which states that the Pressure in a constant Volume is proportional to the Temperature.

The coolant system typically includes a pressure release to allow the coolant pressure to release at a preset limit. The system is closed up until that pressure overlimit is reached. If the pressure is not released in a situation where the engine is overheating and the temperature of the coolant has reached the state change, then serious engine damage can occur, such as blown head gaskets, radiator hoses, or other engine damage.

The coolant will reach a state change into steam or vapor if the temperature is allowed to reach the boiling point for the coolant. Thus it is critical to monitor the temperature of the coolant to prevent this from occurring. The monitoring of the coolant system is normally done by a temperature gauge mounted in the driver dashboard of the vehicle. The temperature gauge relies upon the temperature state of the coolant to notify the vehicle operator of a problem. There typically is a lag in this notification that results in engine damage before the operator can react. Additionally, these temperature gauges are notoriously unreliable. Also, many of the stock temperature gauges are merely lights that may come on when a problem has already occurred, too late to limit the damage to the engine.

There have been attempts to solve these problems in the past. However these attempts are all directed to monitoring the temperature of the coolant. As described above, many times the damage may be occurring prior to the coolant reaching the critical temperature limit at which a temperature gauge might indicate a problem, such as during the initial warm up of the vehicle. The operator would not be aware of a leak in the coolant system or a blockage in the coolant system until the critical temperature has been reached. Thus, the coolant may have already been lost resulting in an inability to cool the engine before damage occurs.

Thus a need exists for a reliable system for monitoring not only the temperature of the coolant but the pressure of the coolant system.

### SUMMARY OF INVENTION

The present invention solves these and other problems by providing a system and method for monitoring the state of a pressurized environment. The system of a preferred embodiment monitors the pressure of the pressurized environment and alerts the operator if the pressure falls below or above preset limits. This allows the operator to prevent or minimize any damage to the pressurized environment.

In a preferred embodiment of the present invention, the system has particularly utility in monitoring the coolant system of an internal combustion engine of an automotive vehicle. The system will alert the driver of changes in the coolant system due to leaks or overheating much faster than a conventional temperature gauge.

The system of this preferred embodiment includes a low pressure switch connected to the coolant system by a manifold and a high pressure switch connected to the manifold. Each of these pressure switches are connected to alert displays, such as LEDs. If the pressure of the coolant system is below a preset limit, the low pressure display will alert the operator. Similarly, if the pressure of the coolant system exceeds a preset limit, the high pressure system will alert the operator.

A pressure gauge can also be incorporated into this system to provide a constant status report of the pressure of the coolant system. This is particularly useful when the LEDs are powered down.

The pressure switches and pressure gauge may be incorporated into a single display unit, preferably in a location that can be viewed by the operator. The pressure gauge may also include a lighted display, even a fluorescent display for night use.

These and other features of the present invention are evident from the ensuing detailed description of preferred embodiments and from the drawings.

### BRIEF DESCRIPTION OF DRAWINGS

FIG. 1 is a perspective view of a preferred embodiment of the state monitoring system of the present invention.

FIG. 2 is a view of the manifold of the embodiment of FIG. 1.

FIG. 3 is a view of the wiring harness of the embodiment of FIG. 1.

FIG. 4 is a view of the pressure gauge of the embodiment of FIG. 1.

### DETAILED DESCRIPTION

The present invention, in a preferred embodiment, provides a system for monitoring the state of coolant in a closed-loop system or partially closed loop system. A preferred embodiment of the present invention is described below. It is to be expressly understood that this descriptive embodiment is provided for explanatory purposes only, and is not meant to unduly limit the scope of the present invention as set forth in the claims. Other embodiments of the present invention are considered to be within the scope of the claimed inventions, including not only those embodiments that would be within the scope of one skilled in the art, but also as encompassed in technology developed in the future.

The descriptive embodiments provided herein describe a system for monitoring the state of coolant in an automotive engine. It is to be expressly understood that the door system have application for use with other types of coolant systems, such as other types of automotive uses, refrigerant systems or any other type of pressurized system.

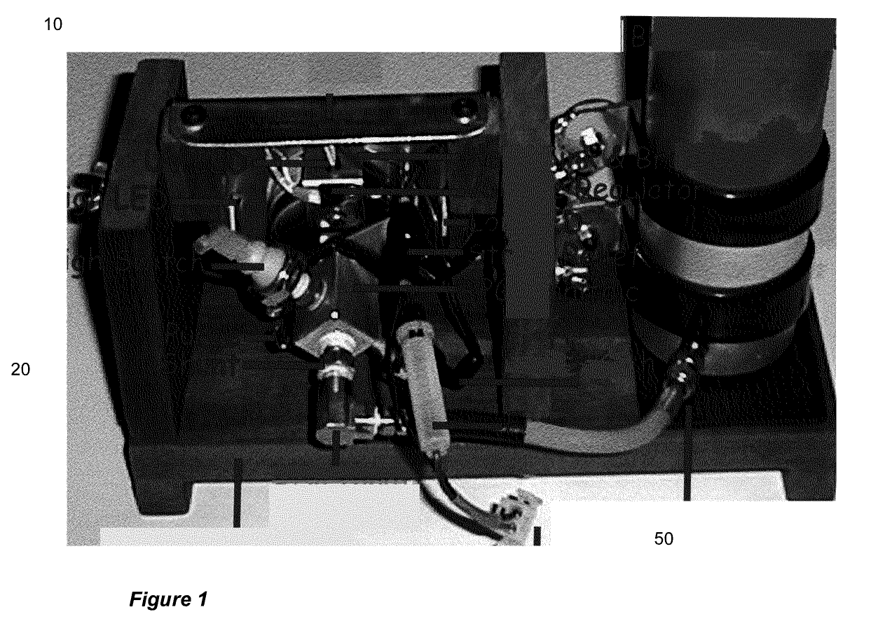

A descriptive embodiment of the system for monitoring the state of coolant in an automotive engine is illustrated in FIG. 1. This embodiment is intended for use on a radiator coolant system on a typical internal combustion engine operating under thirty pounds per square inch (30 psi). The pressure gauge system 10 of this embodiment includes a pressure gauge manifold 20. The pressure gauge manifold is connected to the intake cooling system port of the coolant system of the engine or any other access point within the coolant system. The manifold may be mounted adjacent the coolant system or spaced some distance from the coolant source.

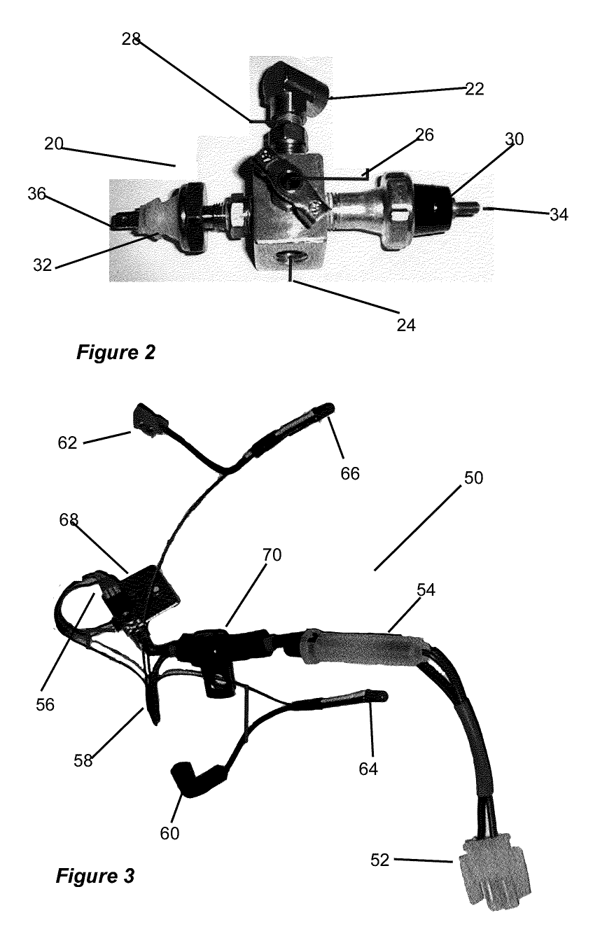

The pressure system manifold 20, as shown in FIG. 2, includes an inlet 22 that is connected to the intake cooling system port (not shown) either directly or via a feed hose or line formed from any appropriate material and an outlet 24 that is connected to the pressure gauge (discussed below). A purge/drain valve 26 is also provided as well. A shunt 28 is also provided to control fluctuations in coolant flow. The manifold also includes a high side pressure switch 30 and a low side pressure switch 32. The switches 30, 32 include electrical contact points 34, 36, respectively for connection to the wiring harness of the pressure monitoring system.

The wiring harness for this descriptive embodiment of the present invention is illustrated in FIG. 3. Wiring harness 50 includes an electrical connector 52 for connection to a DC power source, or an AC power source if necessary. The electrical connector 52 connects through a fuse block 54 to a voltage regulator 56. An ultraviolet LED 58 is connected to the voltage regulator 56 along with the low pressure side terminal 60 and the high pressure side terminal 62. LED 64 is connected to the low pressure side terminal 60 and LED 66 is connected to the high pressure side terminal 62. Heat sink bracket 68 connects the voltage regulator 56 to the gauge housing while a strain relief bracket 70 connects the wiring harness to the gauge housing. The LEDs 58, 64 and 66 can also be mounted in the driver compartment of the vehicle.

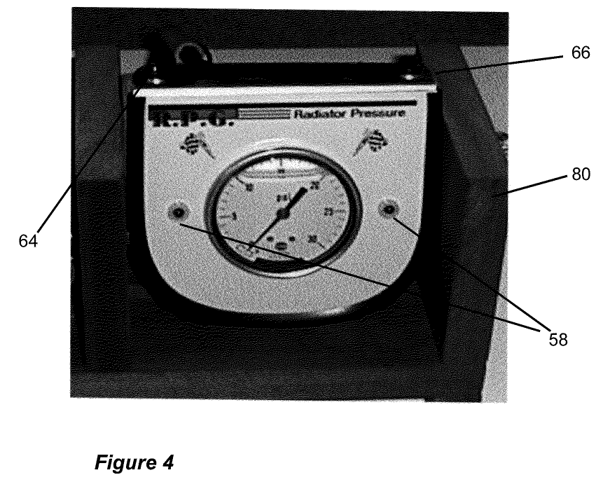

Pressure gauge 80 is connected to the manifold 20 at the outlet 24. The pressure gauge 80 can be mounted directly onto the wiring harness in the engine compartment or in the driver compartment of the vehicle. The low side terminal 60 of the wiring harness 50 is connected to the electrical contact 36 on the low side pressure switch 32. The high side terminal 62 of the wiring harness 50 is connected to the electrical contact 34 on the high side pressure switch 30. A preferred embodiment of the mounted gauge 80 along with LEDs 58, 64 and 66 are shown in FIG. 4. It is to be expressly understood that this descriptive embodiment is provide for explanatory purposes only and is not meant to limit the scope of the claimed inventions.

Operation of the System In use, once the system of this embodiment has been installed, the system will monitor the pressure of the coolant system and provide alerts if the pressure deviates from specified limits. In this embodiment, for use in a typical automotive situation of a 30 psi system, the low pressure limit is set at 4 5 psi while the high pressure limit is set at 24 25 psi. These limits can be altered by changing the gauge scale and/or pressure switches.

Once power is supplied to the monitoring system the power on LED 58 will flash on to show the system is activated. The low pressure LED 64 will then flash on and off until the pressure in the coolant system has reached the low pressure threshold of 4 5 psi. It will then go off and stay off until the pressure falls back below the low pressure threshold. The high-pressure LED 66 will stay off unless the pressure of the coolant system exceeds the high pressure limit of 24 25 psi. The gauge 80 will always display the actual pressure of the coolant system regardless of whether the system is powered on or off.

The system of this preferred embodiment provides immediate alerts as to not only the status of the coolant system but any problems that are occurring in the coolant system in time to prevent or minimize damage to the engine. If a leak is occurring in the system, the pressure will drop until the low pressure alert will provide notification of this problem. If the system is overheating, the increased temperature will cause increased pressure that will cause the high pressure alert to go off. Additionally the pressure gauge will provide the actual status of the system at any time. This is particularly useful when the engine is powered off and the system may be powered off as well. The coolant may still be hot and under high pressure. The pressure gauge will alert the operator of this to prevent injury.

Alternative Embodiments The present invention can include numerous alternative embodiments in addition to the above described embodiment. For example and without limitation, the gauge 80 may be digital, analog, mechanical or electrical. The gauge 80 may be mounted as a stand-alone item, mounted on the dashboard panel, or mounted in a bezel. The gauge may be liquid filled or non-liquid filled.

Also, the LEDs may be of any size, shape or color and may include other types of illumination other than LED. Also, other types of warning alerts may be used, such as audible or visual displays. These warning displays may be mounted with the pressure gauge 80 or mounted separately. In another preferred embodiment, the pressure monitoring system may include either the low pressure and high pressure alerts or the pressure gauge separately.

In another preferred embodiment, the pressure gauge is liquid filled with a fluorescent dye and an ultraviolet LED. This provides a special effect to the gauge particularly during night operation. In this particular embodiment, the gauge is filled with glycerin which is then injected with a fluorescent dye. An ultraviolet LED is fitted into the case of the gauge to provide a unique night glow effect to the gauge face. This particular embodiment not only has application with the above described embodiments but also has utility separate from use with the above described embodiment. For instance, this nightglow pressure gauge may be used in other applications for determining the pressure of a system, or for other measurements as well such as but not limited to temperature, electrical status (voltage, current, power), or any other applicable measurement.

It is to be expressly understood that the above descriptive embodiments are intended for explanatory purposes only. These above embodiments have particular utility in not only passenger cars, vans, pickups and other consumer vehicles but also in race cars, military equipment, industrial equipment, construction equipment, emergency vehicles, government vehicles, recreational vehicles, commercial transportation vehicles, fire trucks, off-road vehicles, commercial trucking vehicles and any other types of engine powered vehicles. While the above embodiments have particular applicability in internal combustion engines, the present invention also has applicability in other pressurized environments, including but not limited to refrigeration systems, heating and ventilation systems and any other type of pressurized system.

These and other types of applications and embodiments are considered to be within the scope of the claimed inventions.

1. A system for monitoring the status of a pressurized environment, said system comprising:
a manifold for connection to said pressurized environment;
a low pressure switch on said manifold;
an alert display connected to said low pressure switch for displaying an alert when the pressure of said environment is below a preset limit;
a high pressure switch on said manifold; and
an alert display connected to said high pressure switch for displaying an alert when the pressure of said environment is above a preset limit.

2. The system of claim 2 wherein said system further includes:
a pressure gauge connected to said manifold for displaying the pressure of said environment.

3. The system of claim 1 wherein said low pressure alert display is an LED display.

4. The system of claim 1 wherein said high pressure alert display is an LED display.

5. The system of claim 2 wherein said pressure gauge is a mechanical pressure gauge.

6. The system of claim 2 wherein said pressure gauge is an analog pressure gauge.

7. The system of claim 2 wherein said pressure gauge is a digital pressure gauge.

8. The system of claim 1 wherein said system further includes:
a pressure gauge connected to said manifold for displaying the pressure of said environment;
said low pressure alert display is an LED display mounted on said pressure gauge; and
said high pressure alert display is an LED display mounted on said pressure gauge.

9. The system of claim 2 wherein said pressure gauge includes:
a fluorescent dye with an ultraviolet light source.

10. The system of claim 1 wherein said pressurized environment includes:
a coolant system for an internal combustion engine.

11. A system for monitoring the status of a pressurized environment, said system comprising:
a manifold for connection to said pressurized environment;
a low pressure switch on said manifold;
an alert display connected to said low pressure switch for displaying an alert when the pressure of said environment is below a preset limit;
a high pressure switch on said manifold;
an alert display connected to said high pressure switch for displaying an alert when the pressure of said environment is above a preset limit; and
a pressure gauge connected to said manifold for displaying the pressure of said pressurized environment.

12. The system of claim 11 wherein said low pressure alert display is an LED display.

13. The system of claim 11 wherein said high pressure alert display is an LED display.

14. The system of claim 11 wherein said pressure gauge is a mechanical pressure gauge.

15. The system of claim 11 wherein said pressure gauge is an analog pressure gauge.

16. The system of claim 11 wherein said pressure gauge is a digital pressure gauge.

17. The system of claim 11 wherein said pressure gauge includes:
a fluorescent dye with an ultraviolet light source.

18. The system of claim 11 wherein said pressurized environment includes:
a coolant system for an internal combustion engine.

19. A method of monitoring the state of a pressurized environment, said method comprising the steps of:
providing a pressure switch for monitoring the low pressure of said environment;
providing a display connected to said pressure switch for displaying an alert when said environment is below a preset lower limit;
providing a pressure switch for monitoring the high pressure of said environment; and
providing a display connected to said high pressure switch for displaying an alert when said environment is above a preset high limit.

20. The method of claim 19 wherein said method further comprises:
providing a pressure gauge for displaying the pressure of said environment.

21. A gauge for measuring the status of a system, said gauge comprising:
a measurement scale;
a mechanism for displaying the status of the system against said measurement scale;
a fluorescent dye in said gauge; and
an ultraviolet light illuminating said fluorescent dye.

22. The gauge of claim 21 wherein said gauge includes:
a pressure gauge.
